(19) United States
(12) Patent Application Publication
(10) Pub. No.: US 2022/0214797 A1
(43) Pub. Date: Jul. 7, 2022

(54) VIRTUAL IMAGE CONTROL METHOD, APPARATUS, ELECTRONIC DEVICE AND STORAGE MEDIUM

(71) Applicant: GUANGZHOU HUYA INFORMATION TECHNOLOGY CO., LTD., Guangzhou, Guangdong (CN)

(72) Inventors: Zihao XU, Guangzhou, Guangdong (CN); Shiqi WU, Guangzhou, Guangdong (CN)

(21) Appl. No.: 17/605,476

(22) PCT Filed: Apr. 27, 2020
(86) PCT No.: PCT/CN2020/087139

§ 371 Date: Oct. 21, 2021

(30) Foreign Application Priority Data
Apr. 30, 2019 (CN) 201910358384.7
Apr. 30, 2019 (CN) 201910358491.X

(51) Int. Cl. G06F 3/04815; H04N 21/2187; G06T 7/73

(52) U.S. Cl. CPC G06F 3/04815; G06T 2207/30244; G06T 7/75; H04N 21/2187

(57) ABSTRACT

Embodiments of the present application relate to the technical field of live broadcasting, and provided are a virtual image control method, apparatus, an electronic device and a storage medium. The virtual image control method comprises: analyzing an anchor video frame sent by a live broadcast initiating terminal, and generating an action control instruction, wherein the anchor video frame is obtained by capturing an anchor using the live broadcast initiating terminal, and the action control instruction is configured to control a virtual image in a live broadcast picture of a live broadcast receiving terminal; determining whether a virtual camera position control instruction corresponding to the anchor is obtained; and if a virtual camera position control instruction is obtained, controlling the virtual image according to the virtual camera position control instruction and the action control instruction. Thus, the virtual image may be displayed at different camera positions to create the effect of a stage performance, thereby increasing the enjoyment of virtual image display and improving the user experience during the live broadcast of a virtual image.

### CROSS-REFERENCE TO RELATED APPLICATION

The present disclosure claims the priority to the Chinese patent application filed with the Chinese Patent Office on Apr. 30, 2019 with the filing No. 201910358491X, and entitled “Virtual Image Control Method, Virtual Image Control Apparatus and Electronic Device”, and the priority to the Chinese patent application filed with the Chinese Patent Office on Apr. 30, 2019 with the filing No. 2019103583847, and entitled “Virtual Image Display Method, Virtual Image Display Apparatus and Electronic Device”, all the contents of which are incorporated herein by reference in entirety.

### TECHNICAL FIELD

The present disclosure relates to the technical field of live streaming, and in particular, provides a virtual image control method, a virtual image control apparatus, an electronic device, and a storage medium.

### BACKGROUND ART

In a scene such as Internet live streaming, in order to improve the interestingness of live streaming, a virtual image may be adopted to replace an actual image of an anchor (compere) and displayed in a live streaming picture. However, in some common live streaming technologies, the control accuracy of the virtual image is generally lower, so that the solution of live streaming with the combination of the virtual image has the problem of insufficient interestingness.

### SUMMARY

An objective of the present disclosure lies in providing a virtual image control method, a virtual image control apparatus, an electronic device, and a storage medium, which can display a virtual image at different camera positions, so as to create the effect of stage performance, and improve the user experience of live streaming with the combination of the virtual image.

In order to realize at least one of the above objectives, a technical solution adopted in the present disclosure is as follows.

An embodiment of the present disclosure provides a virtual image control method. The method includes:

analyzing anchor video frames sent from a live streaming initiating terminal, and generating an action control instruction, wherein the anchor video frames are obtained by shooting an anchor by the live streaming initiating terminal, and the action control instruction is configured to control a virtual image in a live streaming picture of a live streaming receiving terminal;

judging whether a virtual camera position control instruction corresponding to the anchor is obtained, wherein if the virtual camera position control instruction is obtained, the virtual image is controlled according to the virtual camera position control instruction and the action control instruction.

Optionally, as a possible embodiment, the step of judging whether a virtual camera position control instruction corresponding to the anchor is obtained includes:

judging whether the virtual camera position control instruction corresponding to the anchor, sent from the live streaming receiving terminal, is received.

Optionally, as a possible embodiment, the step of judging whether the virtual camera position control instruction corresponding to the anchor, sent from the live streaming receiving terminal, is received includes:

judging, upon receiving the virtual camera position operation instruction sent from the live streaming receiving terminal, whether the virtual camera position operation instruction complies with the first preset condition, wherein the first preset condition is determined based on user historical data corresponding to the live streaming receiving terminal, wherein if the virtual camera position operation instruction complies with the first preset condition, it is determined that the virtual camera position operation instruction is obtained.

Optionally, as a possible embodiment, the step of judging whether the virtual camera position control instruction corresponding to the anchor is obtained includes:

judging whether the virtual camera position control instruction generated based on information corresponding to the anchor is obtained.

Optionally, as a possible embodiment, the step of judging whether the virtual camera position control instruction generated based on information corresponding to the anchor is obtained includes:

judging whether the virtual camera position control instruction generated based on operation information corresponding to the anchor is obtained.

Optionally, as a possible embodiment, the step of judging whether the virtual camera position control instruction generated based on operation information corresponding to the anchor is obtained includes:

judging, upon receiving voice information generated based on the operation information corresponding to the anchor, whether the voice information has first preset information, wherein when the voice information has the first preset information, it is determined that the virtual camera position control instruction generated based on the operation information corresponding to the anchor is acquired.

Optionally, as a possible embodiment, the first preset information includes keyword information and/or melody characteristic information.

Optionally, as a possible embodiment, the step of judging whether the virtual camera position control instruction generated based on information corresponding to the anchor is obtained includes:

judging, based on a result obtained by analyzing the anchor video frames, whether the virtual camera position control instruction generated based on the information corresponding to the anchor is obtained.

Optionally, as a possible embodiment, the step of judging, based on a result obtained by analyzing the anchor video frames, whether the virtual camera position control instruction generated based on the information corresponding to the anchor is obtained includes:

judging, based on image information obtained by extracting information from the anchor video frames, whether the image information has second preset information, wherein when the image information has the second preset information, it is determined that the virtual camera position control instruction generated based on the information corresponding to the anchor is obtained.

Optionally, as a possible embodiment, the second preset information includes action information, depth information, identification object information and/or identification color information.

Optionally, as a possible embodiment, the step of judging whether the virtual camera position control instruction corresponding to the anchor is obtained includes:

judging, upon receiving the virtual camera position operation instruction sent from the live streaming receiving terminal, whether the virtual camera position operation instruction complies with the second preset condition, wherein the second preset condition is determined based on user historical data corresponding to the anchor, wherein if the virtual camera position operation instruction complies with the second preset condition, it is determined that the virtual camera position operation instruction is obtained.

Optionally, as a possible embodiment, the step of controlling the virtual image according to the virtual camera position control instruction and the action control instruction includes:

controlling a display posture of the virtual image in the live streaming picture according to the action control instruction; and

controlling a display size and/or a display angle of the virtual image in the live streaming picture according to the virtual camera position control instruction.

Optionally, as a possible embodiment, the virtual camera position operation instruction includes an angle parameter; and

the step of controlling a display size and/or a display angle of the virtual image in the live streaming picture according to the virtual camera position control instruction includes:

controlling the live streaming picture to stop displaying the anchor video frames, and acquiring a part of three-dimensional viewing angle data corresponding to the angle parameter in three-dimensional image data constructed for the virtual image in advance.

Optionally, as a possible embodiment, the virtual camera position operation instruction includes angle information: and

the step of controlling a display size and/or a display angle of the virtual image in the live streaming picture according to the virtual camera position control instruction includes:

controlling the live streaming picture to stop displaying the anchor video frames, adjusting, according to the anchor video frames, the three-dimensional image data constructed for the virtual image in advance, and acquiring a part of three-dimensional viewing angle data corresponding to the angle parameter in the adjusted three-dimensional image data.

Optionally, as a possible embodiment, the step of adjusting the three-dimensional image data constructed for the virtual image in advance according to the anchor video frames includes:

acquiring coordinate information on a target feature point in the anchor video frames, and calculating coordinate information on other feature points of the virtual image based on the coordinate information; and

adjusting, according to the coordinate information, the three-dimensional image data constructed for the virtual image in advance.

Optionally, as a possible embodiment, the virtual camera position operation instruction includes a zoom parameter; and

the step of controlling a display size and/or a display angle of the virtual image in the live streaming picture according to the virtual camera position control instruction includes:

determining the display size of the virtual image in the live streaming picture according to the zoom parameter and an initial size of the virtual image.

Optionally, as a possible embodiment, the virtual image control method further includes:

acquiring the number of times of displaying the virtual image at the live streaming receiving terminal based on various display angles; and

determining an amount of data when displaying the virtual image based on the display angle according to the number of times of displaying corresponding to various display angles.

Optionally, as a possible embodiment, the step of analyzing anchor video frames sent from a live streaming initiating terminal, and generating an action control instruction includes:

performing image analysis on each anchor video frame sent from the live streaming initiating terminal, and generating the action control instruction according to an image analysis result of each anchor video frame; or

extracting, every preset period, a current video frame in the anchor video frames sent from the live streaming initiating terminal, performing image analysis on the current video frame, and generating the action control instruction according to the image analysis result on the current video frame.

An embodiment of the present disclosure further provides a virtual image control apparatus, wherein the apparatus includes:

a control instruction generating module, configured to analyze anchor video frames sent from a live streaming initiating terminal, and generate an action control instruction, wherein the anchor video frames are obtained by shooting an anchor by the live streaming initiating terminal, and the action control instruction is configured to control the virtual image in the live streaming picture of the live streaming receiving terminal;

a control instruction judging module, configured to judge whether a virtual camera position control instruction corresponding to the anchor is obtained; and

a virtual image control module, configured to control, when the virtual camera position control instruction is obtained, the virtual image according to the virtual camera position control instruction and the action control instruction.

An embodiment of the present disclosure further provides an electronic device, including a memory, a processor, and a computer program stored in the memory and being capable of running on the process, wherein the above virtual image control method is implemented when the computer program runs on the processor.

An embodiment of the present disclosure further provides a computer readable storage medium, in which a computer program is stored, wherein the above virtual image control method is implemented when the program is executed.

### BRIEF DESCRIPTION OF DRAWINGS

FIG. 1 is a block diagram of an electronic device provided in an embodiment of the present disclosure.

FIG. 2 is a schematic flowchart of a virtual image control method provided in an embodiment of the present disclosure.

FIG. 3 is a system block diagram of a live streaming system provided in an embodiment of the present disclosure.

FIG. 4 is an effect schematic diagram of controlling a virtual image based on a zoom parameter provided in an embodiment of the present disclosure.

FIG. 5 is another effect schematic diagram of controlling the virtual image based on the zoom parameter provided in an embodiment of the present disclosure.

FIG. 6 is an effect schematic diagram of controlling the virtual image based on an angle parameter provided in an embodiment of the present disclosure.

FIG. 7 is a schematic diagram of controlling the virtual image based on feature points provided in an embodiment of the present disclosure.

FIG. 8 is a schematic diagram of corresponding relationship between the number of feature points and times of display provided in an embodiment of the present disclosure.

FIG. 9 is a block diagram of functional modules included in a virtual image control apparatus provided in an embodiment of the present disclosure.

Reference signs: 100—electronic device; 102—memory; 104—processor; 106—virtual image control apparatus; 106a—control instruction generating module; 106b—control instruction judging module; 106c—virtual image control module.

### DETAILED DESCRIPTION OF EMBODIMENTS

In order to make objectives, technical solutions, and advantages of the embodiments of the present disclosure clearer, the technical solutions in the embodiments of the present disclosure will be described clearly and completely below in conjunction with accompanying drawings in the embodiments of the present disclosure, and apparently, the embodiments described are some but not all embodiments of the present disclosure. Generally, components in the embodiments of the present disclosure, as described and shown in the accompanying drawings herein, may be arranged and designed in various different configurations.

Therefore, the detailed description below of the embodiments of the present disclosure provided in the accompanying drawings is not intended to limit the scope of the present disclosure claimed, but merely illustrates chosen embodiments of the present disclosure. All of other embodiments obtained by those ordinarily skilled in the art based on the embodiments in the present disclosure without using creative efforts shall fall within the scope of protection of the present disclosure.

It should be noted that similar reference signs and letters represent similar items in the following accompanying drawings, therefore, once a certain item is defined in one accompanying drawing, it is not needed to be further defined or explained in subsequent accompanying drawings. In the description of the present disclosure, terms such as “first” and “second” are merely for distinctive description, but should not be construed as indicating or implying importance in relativity.

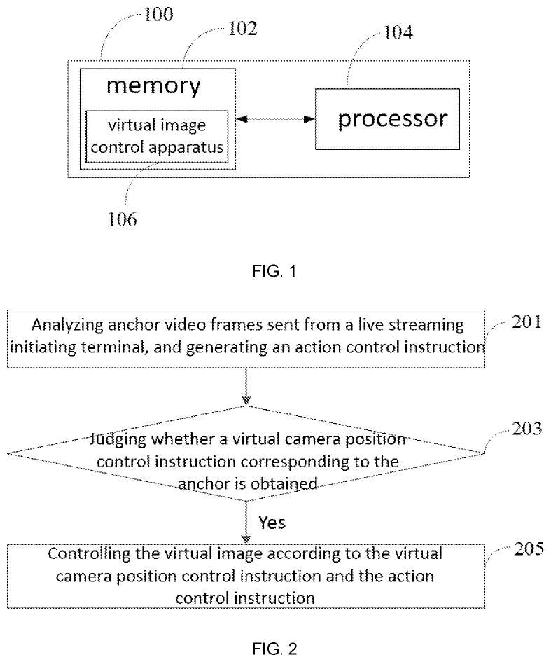

As shown in FIG. 1, an embodiment of the present disclosure provides an electronic device 100, wherein the electronic device 100 may serve as a live streaming device, for example, the electronic device 100 may be a backend server in communication connection with a terminal device used by an anchor in live streaming.

Exemplarily, the electronic device 100 may include a memory 102, a processor 104, and a virtual image control apparatus 106. The memory 102 and the processor 104 may be directly or indirectly electrically connected with each other, so as to realize transmission and interaction of data. For example, the memory 102 and the processor 104 may realize electrical connection via one or more communication buses or signal lines. The virtual image control apparatus 106 may include at least one software functional module that may be stored in the memory 102 in a form of software or firmware. The processor 104 may be configured to execute an executable computer program stored in the memory 102, for example, a software functional module and a computer program included in the virtual image control apparatus 106, so as to perform higher-accuracy control over the virtual image in a live streaming picture.

In the above, in some possible embodiments, the memory 102 may be, but is not limited to, Random Access Memory (RAM), Read Only Memory (ROM), Programmable Read-Only Memory (PROM), Erasable Programmable Read-Only Memory (EPROM), Electric Erasable Programmable Read-Only Memory (EEPROM) and so on.

Besides, the processor 104 may be an integrated circuit chip, with a signal processing function. The above processor 104 may be a general-purpose processor, including Central Processing Unit (CPU), Network Processor (NP), System on Chip (SoC) and the like, and also may be a digital signal processor (DSP), an application-specific integrated circuit (ASIC), a field-programmable gate array (FPGA) or other programmable logic devices, discrete gates, transistor logic devices, or discrete hardware components.

It may be understood that the structure shown in FIG. 1 is merely exemplary, and the electronic device 100 further may include more or fewer components than the structure shown in FIG. 1, or have a different configuration from the structure shown in FIG. 1, for example, the electronic device further may include a communication unit configured to perform information interaction with other live streaming devices (such as a terminal device used by the anchor, a terminal device used by a viewer, etc.).

In combination with FIG. 2, an embodiment of the present disclosure further provides a virtual image control method applicable to the above electronic device 100, wherein method steps defined by the process related to the virtual image control method may be implemented by the electronic device 100. A specific flow shown in FIG. 2 will be described in detail below.

Step 201, analyzing anchor video frames sent from a live streaming initiating terminal, and generating an action control instruction.

In a possible embodiment, the live streaming initiating terminal may shoot an anchor who is performing Internet live streaming, so as to obtain anchor video frames corresponding to the anchor, and send the anchor video frames to the electronic device 100.

As such, the electronic device 100 may receive the anchor video frames sent from the live streaming initiating terminal, perform analysis processing (such as image analysis) on the anchor video frames, and generate the action control instruction based on an analysis result, wherein the action control instruction may be configured to control a virtual image in a live streaming picture of a live streaming receiving terminal.

Step 203, judging whether a virtual camera position control instruction corresponding to the anchor is obtained.

In a possible embodiment, the electronic device 100, after generating the action control instruction in step 201, further may judge whether the virtual camera position control instruction corresponding to the anchor is obtained. Moreover, when it is judged that the virtual camera position control instruction is obtained, step 205 may be executed.

Step 205, controlling the virtual image according to the virtual camera position control instruction and the action control instruction.

In a possible embodiment, the electronic device 100, when judging in Step 203 that the virtual camera position control instruction corresponding to the anchor is obtained, may control the virtual image based on the virtual camera position control instruction and the action control instruction. That is to say, the electronic device 100 may control the virtual image together with the virtual camera position control instruction on the basis of controlling the virtual image based on the action control instruction, thus improving the accuracy of the control.

Moreover, as the virtual camera position control instruction is adopted, it is further possible that the display of the virtual image shows states at different camera positions, so as to create the effect of stage performance in a live streaming room, so that the live streaming has stronger presentation sensibility, so as to increase the interestingness of virtual image display, and improve the user experience.

In the above, it may be understood that, for the anchor video frames analyzed by the electronic device 100 when executing Step 201, the embodiments of the present disclosure do not limit the manner in which the electronic device 100 acquires the anchor video frames.

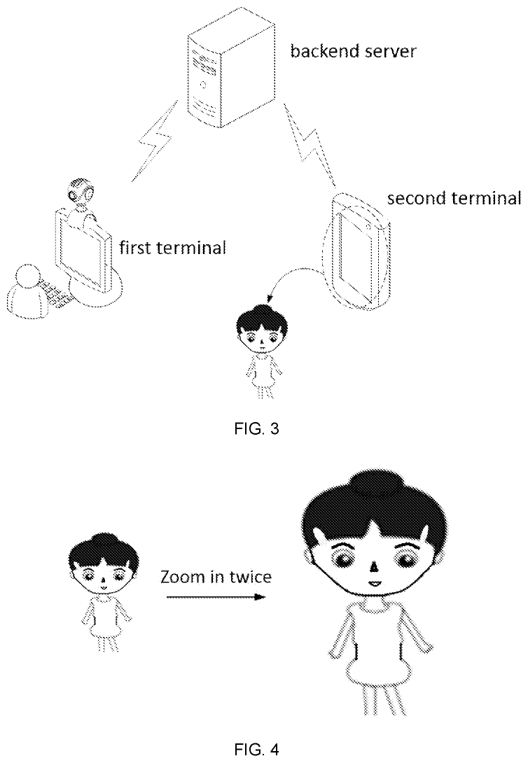

For example, in a possible embodiment, in combination with FIG. 3, the electronic device 100 may be a backend server, which is in communication connection with a first terminal, and the first terminal further may be in communication connection with an image acquisition device (such as a camera). The first terminal may be a terminal device (such as a mobile phone, a tablet computer, and a computer) used by the anchor in live streaming, and the image acquisition device may be configured to perform image acquisition for the anchor when the anchor is doing the live streaming, so as to obtain the anchor video frames and send the anchor video frames to the backend server through the first terminal.

It should be noted that the above image acquisition device may be used as a separate device or integrated with the first terminal in one piece; for example, in some possible embodiments, the image acquisition device may be a camera carried by a terminal device such as a mobile phone, a tablet computer, and a computer.

Moreover, the embodiments of the present disclosure do not limit the manner in which the electronic device 100 performs Step 201 to analyze the anchor video frames. For example, in a possible embodiment, when executing Step 201, the electronic device 100 may extract a video frame in the anchor video frames at random, and generate a corresponding action control instruction based on the extracted video frame.

For another example, in another possible embodiment, when executing Step 201, the electronic device may extract, every preset period, a current video frame in the anchor video frames sent from the live streaming initiating terminal, perform image analysis on the current video frame, and generate the action control instruction according to the image analysis result on the current video frame.

That is to say, after acquiring the anchor video frames sent from the live streaming initiating terminal, the electronic device 100 may extract, every preset period, a video frame (namely, a current anchor video frame) from the anchor video frames; then, perform the image analysis processing (such as feature extraction) on the extracted video frame; and finally, may generate a corresponding action control instruction based on a result of the analysis processing.

As such, as the electronic device performs the video frame extraction according to a certain period, when controlling the action of the virtual image according to the action control instruction generated by the extracted video frame, not only a real action of the anchor can be reflected to a larger extent, but also the data processing amount can be reduced, the pressure of the corresponding processor can be mitigated, and the real-time performance of the live streaming can be better.

It should be noted that, the embodiments of the present disclosure do not limit an execution strategy of the above preset period, for example, the preset period may be preset duration (for example, 0.1 s, 0.2 s, 0.3 s), that is to say, a video frame extraction operation may be performed once at every preset duration to obtain one video frame; the preset period also may be preset number of frames (1 frame, 2 frames, 3 frames, etc.), that is to say, the video frame extraction operation may be performed once at every preset number of frames to obtain one video frame.

For another example, in another possible embodiment, in Step 201, the electronic device 100 further may perform the image analysis on each anchor video frame in the anchor video frames sent from the live streaming initiating terminal, and generate the action control instruction according to the image analysis result of each anchor video frame.

That is to say, for all the acquired anchor video frames sent from the live streaming initiating terminal, the electronic device 100 may extract each anchor video frame, then perform the image analysis processing (such as feature extraction) on each extracted anchor video frame, and finally, may generate the corresponding action control instruction based on the image analysis result of each anchor video frame.

As such, as the electronic device generates the corresponding action control instruction according to each anchor video frame, respectively, when the virtual image is controlled based on the action control instruction, the action of the virtual image can be allowed to completely reflect the real action of the anchor, so that the display of the virtual image is more flexible and the connection between the actions is smoother, so as to improve the viewing experience of the viewer.

It should be noted that, when executing Step 201 to perform the processing such as image analysis and feature extraction, the electronic device 100 may identify the anchor video frames using a trained neural network, so as to obtain an action posture of the anchor in the anchor video frames, and generate the action control instruction based on the action posture.

Besides, in some possible examples of the embodiments of the present disclosure, when executing Step 203, the electronic device 100 may judge whether the virtual camera position control instruction corresponding to the anchor sent from the live streaming receiving terminal is received; that is to say, the live streaming receiving terminal may directly send the virtual camera position control instruction to the electronic device 100, so that the electronic device 100 executes Step 205 according to the received virtual camera position control instruction, so that the live streaming receiving terminal may control the virtual image corresponding to the anchor.

In the above, in some possible embodiments, when the electronic device 100 receives a virtual camera position operation instruction sent from the live streaming receiving terminal, the electronic device 100 may judge, based on a first preset condition determined according to user historical data corresponding to the live streaming receiving terminal, whether the virtual camera position operation instruction complies with the first preset condition; and if the virtual camera position operation instruction complies with the first preset condition, the electronic device 100 may determine that the virtual camera position operation instruction is obtained.

That is to say, first, the electronic device 100 will detect whether the virtual camera position operation instruction sent from the live streaming receiving terminal is received, then, upon receiving the virtual camera position operation instruction, judge whether the virtual camera position operation instruction complies with the first preset condition determined based on the user historical data, and finally, determine that the virtual camera position operation instruction is obtained only when the virtual camera position operation instruction complies with the first preset condition.

As such, only a user having specific user historical data can control the display of the virtual image, thus improving the enthusiasm of the user for watching the live streaming.

In the above, in some possible embodiments, specific contents of the above user historical data may include, but are not limited to, the level of the user, the duration of watching the live streaming, the number of comments sent, the number or value of gifts given, etc. For example, only when the level of the user reaches a certain level (e.g. level 10, level 15), can the electronic device 100 determine that the virtual camera position control instruction is obtained when receiving the virtual camera position control instruction.

It should be noted that the electronic device 100, when judging whether the virtual camera position operation instruction is obtained based on the user historical data, further may perform more accurate determination. For example, based on different user historical data, it may be determined that types of the virtual camera position operation instructions that can be obtained are also different.

In a possible embodiment, the user historical data being the user level is taken as an example for illustration. It is assumed that there are five types of virtual camera position operation instructions, namely, a first operation instruction, a second operation instruction, a third operation instruction, a fourth operation, and a fifth operation instruction. If the user level belongs to an interval [0,5], only when the first operation instruction is received, it can be determined that the operation instruction is obtained; if the user level belongs to an interval (5, 10], only when the first operation instruction or the second operation instruction is received, it can be determined that the operation instruction is obtained; likewise, when the user level belongs to an interval (20, +∞), when any one of the five virtual camera position operation instructions is received, it may be determined that the operation instruction is obtained.

In addition, in some other possible examples of the embodiments of the present disclosure, when executing Step 203, the electronic device 100 further may judge whether the virtual camera position control instruction generated based on information corresponding to the anchor is obtained in a manner such as information extraction; that is to say, it is also possible that the live streaming initiating terminal does not directly send the virtual camera position control instruction to the electronic device 100, but the electronic device extracts and generates based on the information corresponding to the anchor, so as to execute Step 205 according to the extracted and generated virtual camera position control instruction.

Moreover, when the electronic device 100 judges whether the virtual camera position control instruction generated based on the information on the anchor is obtained, judging manners may be different according to different manners of generating the virtual camera position control instruction.

For example, in a possible embodiment (Example 1), the virtual camera position control instruction may be generated based on operation information corresponding to the anchor. Exemplarily, the above first terminal may generate a corresponding virtual camera position control instruction in response to the operation of anchor, and send the virtual camera position control instruction to the above backend server. Moreover, upon receiving the virtual camera position control instruction, the backend server may determine that the virtual camera position control instruction is obtained.

In the above, in a solution provided in an embodiment of the present disclosure, the manner in which the anchor operates the first terminal is not limited, and may include, but is not limited to, operations of the anchor on an input device such as a key (such as a physical key or a screen virtual key), a keyboard, a mouse, and a microphone on the first terminal. For example, the anchor not only may input a piece of text information through a keyboard or input a piece of voice information through a microphone (e.g., “zoom in two times” or “display back side”, or some simple numbers or words, for example, “1”, meaning zoom in 1 time, and “2”, meaning zoom in 2 times, as long as corresponding relationships are established in advance), but also may execute a specific action (for example, after clicking the virtual image displayed by the first terminal, moving the mouse to the left, to the right and so on, wherein after the first terminal identifies this action, the corresponding virtual camera position control instruction may be generated based on the corresponding relationship established in advance) with the mouse.

That is to say, in a possible embodiment, upon receiving the voice information generated based on the operation information (operating the first terminal device through the microphone) corresponding to the anchor, the electronic device 100 may judge whether the voice information has first preset information, and when the voice information has the first preset information, determine that the virtual camera position control instruction generated based on the operation information corresponding to the anchor is acquired.

In the above, exemplarily, the first preset information above may be keyword information or other information. For example, when the voice information is a song (for example, played by the device or sung by the anchor), the first preset information above further may be melody characteristic information. That is to say, the electronic device 100 may identify the melody characteristic of the voice information sent from the first terminal using the trained neural network, and determine the virtual camera position control instruction according to the identified melody characteristic. For example, in a gentle melody, the electronic device 100 may generate a control instruction that makes an overhead camera position get farther away. In a melody of climax or chorus, the electronic device 100 may generate a control instruction that makes a camera position of the face to be enlarged.

For another example, in another possible embodiment (Example 2), the virtual camera position control instruction further may be generated according to a result obtained by analyzing the anchor video frames when the electronic device 100 executes Step 201.

That is to say, the electronic device 100 further may judge, based on a result obtained by analyzing the anchor video frames sent from the live streaming initiating terminal, whether the virtual camera position control instruction generated based on the information corresponding to the anchor is obtained.

Exemplarily, the electronic device 100 may extract information on the anchor video frames, so as to judge whether the obtained image information has second preset information, and when the obtained image information has the second preset information, the electronic device 100 may generate a corresponding virtual camera position control instruction based on the second preset information, and determine that the virtual camera position control instruction is acquired.

In the above, the embodiments of the present disclosure do not limit the specific content of the second preset information above, for example, the second preset information may include, but is not limited to, action information, depth information, or other information. For example, exemplarily, in a possible embodiment, the second preset information above may be action information.

That is to say, in some possible embodiments, the electronic device 100 may generate a corresponding virtual camera position control instruction based on a specific action of the anchor, for example, when the anchor extends out the left hand, a control instruction for displaying a left side of the virtual image may be generated; when the anchor extends out the right hand, a control instruction for displaying a right side of the virtual image may be generated; when the left hand and the right hand of the anchor are in contact, a control instruction for displaying a back side of the virtual image may be generated; and when the anchor crouches, a control instruction for displaying the top of head of the virtual image may be generated.

In a possible embodiment, the other information above may be information such as identification object or identification color. That is to say, the anchor may carry an identification object or wear clothes or accessories having an identification color, so that when executing Step 203, the electronic device 100 may obtain the virtual camera position control instruction in a manner of identifying the identification object or the identification color.

For example, in some possible embodiments, a control instruction that makes the camera position get closer may be generated according to the fact that identified objects are from large to small or the identified color is red, orange, yellow, green, cyan, blue or purple. That is to say, when the anchor carries a plurality of identification objects of different sizes in different parts, or the anchor wears clothes or accessories with various colors, if the anchor has different actions at different moments, the electronic device 100, when executing Step 203, may control the virtual image to show a stage effect from distant view to close view or from close view to distant view according to different identification objects or identification colors identified.

In addition, in some possible embodiments, in order to improve the enthusiasm of the anchor for live streaming, when executing Step 203, the electronic device 100 further may judge whether the virtual camera position control instruction is obtained based on the historical live streaming data corresponding to the anchor.

Exemplarily, in the above Example 1, after the electronic device 100 receives the virtual camera position control instruction sent from the first terminal, or in the above Example 2, after the corresponding virtual camera position control instruction is generated based on the first preset information or the second preset information, the electronic device 100 further may determine a second preset condition based on the user historical data corresponding to the anchor, and judge whether the virtual camera position control instruction complies with the second preset condition. Moreover, only when the virtual camera position control instruction complies with the second preset condition, it can be determined that the virtual camera position control instruction is obtained.

In the above, in a possible embodiment, the historical live streaming data corresponding to the anchor above may be anchor level, and the higher the level is, the larger the number of obtained virtual camera position control instructions can be determined. For example, if the anchor level is less than 5, it may be determined that no virtual camera position control instruction can be obtained; if the anchor level is greater than or equal to 5, and less than or equal to 10, it may be determined that a part of the virtual camera position control instruction can be obtained; and if the anchor level is greater than 10, it may be determined that any virtual camera position control instruction can be obtained.

It should be noted that, in the above example, whether the virtual camera position control instruction is obtained is judged according to a certain level range, and in some other examples, it is also possible that different virtual camera position control instructions that may be obtained are determined for each level.

In addition, in some other possible examples of the embodiments of the present disclosure, the historical live streaming data corresponding to the anchor above further may include the number or value of gifts received by the anchor during the live streaming, the number of comments of viewers during the live streaming of the anchor, the maximum number of viewers watching the live streaming during the live streaming of the anchor, and so on. For example, the larger the number or the higher the value of received gifts is, the larger the number of comments is, or the larger the maximum number of viewers is, the more the virtual camera position control instructions that can be obtained can be determined.

Moreover, after executing Step 203 to judge whether the virtual camera position control instruction is obtained, on the one hand, when determining that the virtual camera position control instruction is obtained, the electronic device 100 may execute Step 205. On the other hand, when it is determined that the virtual camera position control instruction is not obtained, a specific processing manner is not limited. For example, in a possible embodiment, the electronic device 100 may control the virtual image according to the action control instruction.

That is to say, when the anchor is doing the live streaming, if obtaining the virtual camera position control instruction, the electronic device 100 controls the virtual image according to the virtual camera position control instruction and the action control instruction; and if not obtaining the virtual camera position control instruction, the electronic device 100 controls the virtual image only according to the action control instruction.

In addition, the embodiments of the present disclosure do not limit the manner in which the electronic device 100 executes Step 205, and may make selection according to actual application requirements, such as the performance of the processor 104 and the control accuracy of the virtual image.

For example, in a possible embodiment, the manner in which the electronic device 100 executes Step 205 may be as follows: controlling a display posture of the virtual image in the live streaming picture according to the action control instruction; controlling a display size of the virtual image in the live streaming picture according to the virtual camera position control instruction or controlling a display angle of the virtual image in the live streaming picture; or controlling the display size and the display angle of the virtual image in the live streaming picture.

That is to say, on the one hand, the electronic device 100 may control the display posture of the virtual image according to the action control instruction; on the other hand, on the basis of controlling the display posture of the virtual image, the electronic device 100 further may control the display size of the virtual image in the display posture, based on the obtained virtual camera position control instruction, or control the display angle of the virtual image in the display posture, or control the display size and the display angle of the virtual image in the display posture.

For example, if the anchor is currently dancing, the electronic device 100 may control the virtual image to perform dancing based on the action control instruction. In this case, if obtaining the virtual camera position control instruction, the electronic device 100 may control different display sizes of the virtual image in a dancing state according to the virtual camera position control instruction, or control different display angles of the virtual image in the dancing state, or control different display sizes and different display angles of the virtual image in the dancing state.

In the above, in some possible embodiments, the above display posture may include, but is not limited to, actions such as kicking, clapping hands, bending down, shaking shoulders, and shaking head, and expressions such as frowning, laughing, smiling, and glaring. Moreover, the embodiments of the present disclosure do not limit the manner of controlling the virtual image, either. In a possible embodiment, the electronic device 100 may perform control based on a predetermined feature point.

In addition, as a possible embodiment, in order to improve the user experience, the electronic device 100 further may perform corresponding control over the virtual image based on the information carried in the virtual camera position operation instruction. That is to say, the user may perform different operations on the live streaming receiving terminal, so that the live streaming receiving terminal may generate a virtual camera position operation instruction carrying different pieces of information based on different operations.

In the above, the embodiments of the present disclosure do not limit the manner in which the user operates the live streaming receiving terminal, for example, the operation manner may include the user operating an input device such as a touch screen, a mouse, a keyboard, and a microphone. Moreover, the embodiments of the present disclosure do not limit the information carried in the virtual camera position operation instruction, either, and the information may be selected according to actual application requirements.

For example, in a possible embodiment, the virtual camera position operation instruction may include a zoom parameter. That is to say, when executing Step 205, the electronic device 100 may control the display size of the virtual image displayed in the live streaming picture of the live streaming receiving terminal according to the zoom parameter and the initial size of the virtual image in the anchor video frames.

In the above, according to different requirements of control accuracy, the manner in which the electronic device 100 controls the display size of the virtual image according to the zoom parameter also may be different.

For example, when the requirements of the control accuracy are lower, if the virtual camera position operation instruction obtained by the electronic device 100 includes the zoom parameter, the electronic device 100 controls the virtual image to be enlarged by a specific factor (for example, 2 times, 3 times, or 5 times) based on the initial size or to be zoomed out by a specific factor (for example, 0.2 times, 0.5 times, or 0.8 times).

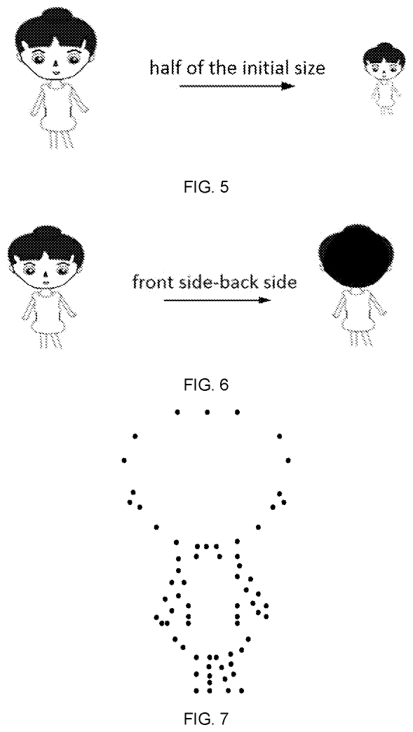

For another example, when the requirements of the control accuracy are higher, the electronic device 100 may control the virtual image to be enlarged or zoomed out by different factors on the basis of the initial size according to the specific numerical value of the zoom parameter in the virtual camera position operation instruction. As shown in FIG. 4, when the zoom parameter is 2, the virtual image may be controlled to be enlarged by a factor of 2 on the basis of the initial size; and as shown in FIG. 5, when the zoom parameter is 0.5, the virtual image may be controlled to be reduced to a half of the initial size on the basis of the initial size.

For another example, in another possible embodiment, the virtual camera position operation instruction may include an angle parameter. As such, when executing Step 205, the electronic device 100 may control the display angle of the virtual image displayed in the live streaming picture of the live streaming receiving terminal according to the angle parameter.

By the same reasoning, according to different requirements of control accuracy, the manner in which the electronic device 100 controls the display angle of the virtual image according to the angle parameter also may be different.

For example, when the requirements of the control accuracy are lower, if the virtual camera position operation instruction obtained by the electronic device 100 includes the angle parameter, the electronic device 100 may control the virtual image to be displayed at a specific angle (for example, a back side, a left side or a right side).

For another example, when the requirements of the control accuracy are higher, the electronic device 100 may control the virtual image to be displayed at a corresponding angle according to the specific numerical value of the angle parameter in the virtual camera position operation instruction. As shown in FIG. 6, when the angle parameter is 180°, the electronic device 100 may control the virtual image to display the back side; when the angle parameter is 90°, the electronic device 100 may control the virtual image to display the left side; and when the angle parameter is 270°, the electronic device 100 may control the virtual image to display the right side.

It should be noted that according to different actual application requirements, an operation mode in which the electronic device 100 controls the virtual image based on the angle parameter also may be different.

For example, in a possible embodiment, when controlling the virtual image according to the angle parameter, the electronic device 100 may control the live streaming picture of the live streaming receiving terminal to stop displaying the anchor video frames, and acquire a part of three-dimensional viewing angle data corresponding to the angle parameter in three-dimensional image data constructed for the virtual image in advance.

That is to say, in the process of displaying the anchor video frames on the live streaming picture of the live streaming receiving terminal, if the user operates the live streaming receiving terminal, so that the live streaming receiving terminal generates a corresponding virtual camera position operation instruction and sends the virtual camera position operation instruction to the electronic device 100 (backend server), the electronic device 100 may stop sending the anchor video frames to the live streaming receiving terminal based on the virtual camera position operation instruction, so as to control the live streaming picture of the live streaming receiving terminal to stop displaying the anchor video frames.

Moreover, the electronic device 100 may acquire a corresponding part of three-dimensional viewing angle data from the three-dimensional image data constructed for the virtual image in advance according to the angle parameter in the virtual camera position instruction. For example, if the angle parameter is 90°, the electronic device 100 may acquire a part of three-dimensional viewing angle data corresponding to the left side in the three-dimensional image data; and if the angle parameter is 180°, the electronic device 100 may acquire a part of three-dimensional viewing angle data corresponding to the back side in the three-dimensional image data. Finally, the electronic device 100 sends the acquired part of three-dimensional viewing angle data to the live streaming receiving terminal for visualization processing, so as to complete the control over the virtual image. As such, a part of three-dimensional viewing angle data corresponding to the angle parameter may be acquired more quickly, so that the data processing amount is smaller, and the live streaming may be effectively ensured to have higher real-time performance.

For another example, in another possible embodiment, when controlling the virtual image according to the angle parameter, the electronic device 100 may control the live streaming picture of the live streaming receiving terminal to stop displaying the anchor video frames, adjust the three-dimensional image data constructed for the virtual image in advance according to the anchor video frames, and acquire a part of the three-dimensional viewing angle data corresponding to the angle parameter in the adjusted three-dimensional image data.

That is to say, in the process of displaying the anchor video frames on the live streaming picture of the live streaming receiving terminal, if the user operates the live streaming receiving terminal, so that the live streaming receiving terminal generates a corresponding virtual camera position operation instruction and sends the virtual camera position operation instruction to the electronic device 100 (backend server), the electronic device 100 may stop sending the anchor video frames to the live streaming receiving terminal based on the virtual camera position operation instruction, so as to control the live streaming picture of the live streaming receiving terminal to stop displaying the anchor video frames.

Moreover, the electronic device 100 may adjust the three-dimensional image data constructed for the virtual image in advance according to the anchor video frames, so as to obtain new three-dimensional image data. Then, a part of the three-dimensional viewing angle data corresponding to the angle parameter is acquired from the new three-dimensional image data. For example, if the angle parameter is 90°, the electronic device 100 may acquire a part of three-dimensional viewing angle data corresponding to the left side in the new three-dimensional image data; and if the angle parameter is 180°, the electronic device 100 may acquire a part of three-dimensional viewing angle data corresponding to the back side in the new three-dimensional image data. Finally, the electronic device 100 may send the acquired part of three-dimensional viewing angle data to the live streaming receiving terminal for visualization processing, so as to complete the control over the virtual image. As such, the acquired part of three-dimensional viewing angle data may reflect the actual action of the anchor to a larger extent, so that the virtual image also can be more vivid when displaying different angles, thereby improving the user experience.

In the above, the embodiments of the present disclosure do not limit the manner in which the electronic device 100 adjusts the three-dimensional image data according to the anchor video frames. For example, in a possible embodiment, the electronic device 100 may adjust the three-dimensional image data in the following manner: the electronic device 100 may acquire coordinate information on a target feature point in the anchor video frames, and calculate coordinate information on other feature points of the virtual image based on the coordinate information; then the three-dimensional image data constructed for the virtual image in advance is adjusted according to the coordinate information.

That is to say, the electronic device 100 may acquire coordinate information (three-dimensional coordinates, with depth information) on each target feature point (each target feature point on a front side of the virtual image, such as feature points corresponding to the eyes, nose, mouth, and ears) in the anchor video frames; then, the electronic device 100 may calculate, based on the acquired coordinate information, coordinate information on other feature points (feature points other than the target feature point in the three-dimensional model of the virtual image, such as feature points that only can be seen from the back side) of the virtual image; finally, the electronic device 100 may adjust a part of the data corresponding to other feature points in the three-dimensional image data constructed in advance based on the coordinate information on the other feature points, so as to obtain new three-dimensional image data.

In the above, an algorithm for calculating coordinate information on other feature points based on the coordinate information on the target feature points may be an inverse motion algorithm.

It should be noted that, after adjusting various feature points in the anchor video frames according to the above solutions provided in the embodiments of the present disclosure, the video frames played by the live streaming receiving terminal is based on data after adjusting a part of the three-dimensional viewing angle data (front side part) in the three-dimensional image data. In addition, with respect to the above target feature points, the adjustment of data has been completed, therefore, in the above solutions provided in the embodiments of the present disclosure, only a part of data corresponding to the other feature points needs to be adjusted.

In addition, in order to also be able to control the amount of data displayed when the virtual image is displayed according to actual application requirements, when controlling the virtual image, for example, when the real-time performance requirement is higher, a lower amount of data may be displayed, and when the control accuracy requirement is higher, a higher amount of data may be displayed.

In a possible embodiment, in order to ensure that the processing amount of data still can be lower on the basis of having higher control accuracy so as to guarantee the user experience so that the real-time performance of live streaming of the virtual image is better, the electronic device 100 may determine the amount of data displayed when displaying the virtual image through the following steps: acquiring the number of times of displaying the virtual image at the live streaming receiving terminal based on various display angles; and determining an amount of data when displaying the virtual image based on the display angle according to the number of times of display corresponding to various display angles.

That is to say, the electronic device 100 may acquire the number of times of display of the virtual image corresponding to various display angles in the whole live streaming period or in a more recent live streaming period, for example, it is assumed that within the last month, the number of times of display corresponding to the display angle of 90° (left side) is 3000, the number of times of display corresponding to the display angle of 180° (back side) is 7000, and the number of times of display corresponding to the display angle of 270° (right side) is 2000.

Then, the electronic device 100 may determine the data amount of the corresponding display angle based on the acquired each number of times of display. For example, if the number of times of display is larger, the amount of data displayed can be controlled to be larger when displaying the corresponding display angle. Thus, in the above example, since the number of times of display (7000 times) is the largest when the display angle is 180° (back side), the electronic device 100 may control that the amount of data during displaying based on this display angle is also the largest; and since the number of times of display (2000 times) is the smallest when the display angle is 270° (right side), the electronic device 100 may control that the amount of data during displaying based on this display angle is also the smallest.

In the above, considering that a predetermined feature point is generally controlled when controlling the virtual image, the above amount of data may refer to the number of feature points. That is to say, the number of feature points when the virtual image is displayed based on the display angle may be determined according to the number of times of display corresponding to various display angles (as shown in FIG. 7).

For example, in the above example, when the display angle is 180° (back side), the number of times of display is 7000, and correspondingly, the number of feature points that may be controlled may be 300; when the display angle is 90° (left side), the number of times of display is 3000, and correspondingly, the number of feature points that may be controlled may be 200; when the display angle is 270° (right side), the number of times of display is 2000, and correspondingly, the number of feature points that may be controlled may be 150.

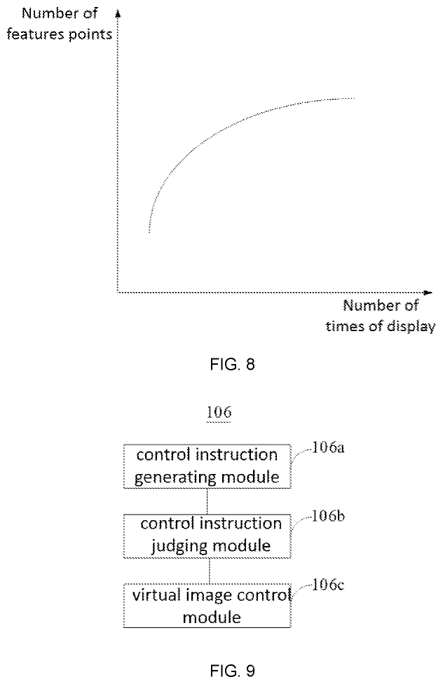

Exemplarily, in a possible embodiment, the electronic device 100 may establish a corresponding relationship between the number of feature points and the number of times of display in advance, so that after the number of times of display is acquired, the number of feature points may be directly obtained according to the corresponding relationship. As shown in FIG. 8, the corresponding relationship may be: the larger the number of times of display is, the larger the number of corresponding feature points is.

In combination with FIG. 9, an embodiment of the present disclosure further provides a virtual image control apparatus 106 applicable to the above electronic device 100. In the above, the virtual image control apparatus 106 may include a control instruction generating module 106a, a control instruction judging module 106b, and a virtual image control module 106c.

The control instruction generating module 106a may be configured to analyze anchor video frames sent from a live streaming initiating terminal, and generate an action control instruction, wherein the anchor video frames are obtained by shooting an anchor by the live streaming initiating terminal, and the action control instruction is configured to control the virtual image in the live streaming picture of the live streaming receiving terminal; in an embodiment, the control instruction generating module 106a may execute Step 201 shown in FIG. 2, and for the relevant contents of the control instruction generating module 106a, reference may be made to the foregoing description of Step 201 in the embodiments of the present disclosure.

The control instruction judging module 106b may be configured to judge whether a virtual camera position control instruction corresponding to the anchor is obtained. In an embodiment, the control instruction judging module 106b may execute Step 203 shown in FIG. 2. For the relevant contents of the control instruction judging module 106b, reference may be made to the foregoing description of Step 203 in the embodiments of the present disclosure.

The virtual image control module 106c may be configured to control the virtual image according to the virtual camera position control instruction and the action control instruction when the virtual camera position control instruction is obtained. In an embodiment, the virtual image control module 106c may execute Step 205 shown in FIG. 2. For the relevant contents of the virtual image control module 106c, reference may be made to the foregoing description of Step 205 in the embodiment of the present disclosure.

In the above, when the control instruction judging module 106b judges that the virtual camera position control instruction is not obtained, the virtual image control module 106c further may be configured to control the virtual image according to the action control instruction.

In the embodiments of the present disclosure, corresponding to the above virtual image control method, a computer readable storage medium is further provided, wherein a computer program is stored in the computer readable storage medium, and various steps of the above virtual image control method are executed when the computer program runs.

In the above, various steps executed when the above computer program runs are not further described herein, and reference may be made to the foregoing explanation of the virtual image control method.

In summary, the present disclosure provides a virtual image control method, a virtual image control apparatus, an electronic device, and a storage medium. On the basis of controlling the virtual image based on the anchor video frames sent from the live streaming initiating terminal, if the virtual camera position control instruction corresponding to the anchor is further obtained, the virtual image further may be controlled in combination with the virtual camera position control instruction, so as to display the virtual image in different camera positions, thereby creating the effect of stage performance, further improving the interestingness of the virtual image display, and improving the user experience during the live streaming of the virtual image.

The above-mentioned are merely for some embodiments of the present disclosure and not used to limit the present disclosure, and for one skilled in the art, various modifications and changes may be made to the present disclosure. Any modifications, equivalent substitutions, improvements and so on, within the spirit and principle of the present disclosure, should be covered within the scope of protection of the present disclosure.

### INDUSTRIAL APPLICABILITY

On the basis that the virtual image is controlled based on the anchor video frames sent from the live streaming initiating terminal, if the virtual camera position control instruction corresponding to the anchor is further obtained, the virtual image further may be controlled in combination with the virtual camera position control instruction, so as to display the virtual image in different camera positions, thereby creating the effect of stage performance, further improving the interestingness of virtual image display, and improving the user experience during the live streaming of the virtual image.

1. A virtual image control method, wherein the method comprises following steps:
analyzing anchor video frames sent from a live streaming initiating terminal, and generating an action control instruction, wherein the anchor video frames are obtained by shooting an anchor by the live streaming initiating terminal, and the action control instruction is configured to control a virtual image in a live streaming picture of a live streaming receiving terminal; and
judging whether a virtual camera position control instruction corresponding to the anchor is obtained, wherein if the virtual camera position control instruction is obtained, the virtual image is controlled according to the virtual camera position control instruction and the action control instruction.

2. The virtual image control method according to claim 1, wherein the step of judging whether a virtual camera position control instruction corresponding to the anchor is obtained comprises a following step:
judging whether a virtual camera position control instruction corresponding to the anchor sent from the live streaming receiving terminal is received.

3. The virtual image control method according to claim 2, wherein the step of judging whether a virtual camera position control instruction corresponding to the anchor sent from the live streaming receiving terminal is received comprises a following step:
judging, upon receiving a virtual camera position operation instruction sent from the live streaming receiving terminal, whether the virtual camera position operation instruction complies with a first preset condition, wherein the first preset condition is determined based on user historical data corresponding to the live streaming receiving terminal, wherein if the virtual camera position operation instruction complies with the first preset condition, it is determined that the virtual camera position operation instruction is obtained.

4. The virtual image control method according to claim 1, wherein the step of judging whether a virtual camera position control instruction corresponding to the anchor is obtained comprises a following step:
judging whether a virtual camera position control instruction generated based on information corresponding to the anchor is obtained.

5. The virtual image control method according to claim 4, wherein the step of judging whether a virtual camera position control instruction generated based on information corresponding to the anchor is obtained comprises a following step:
judging whether a virtual camera position control instruction generated based on operation information corresponding to the anchor is obtained.

6. The virtual image control method according to claim 5, wherein the step of judging whether a virtual camera position control instruction generated based on operation information corresponding to the anchor is obtained comprises a following step:
judging, upon receiving voice information generated based on the operation information corresponding to the anchor, whether the voice information has first preset information, wherein when the voice information has the first preset information, it is determined that the virtual camera position control instruction generated based on the operation information corresponding to the anchor is acquired.

7. The virtual image control method according to claim 6, wherein the first preset information comprises keyword information and/or melody characteristic information.

8. The virtual image control method according to claim 4, wherein the step of judging whether a virtual camera position control instruction generated based on information corresponding to the anchor is obtained comprises a following step:
judging, based on a result obtained by analyzing the anchor video frames, whether the virtual camera position control instruction generated based on the information corresponding to the anchor is obtained.

9. The virtual image control method according to claim 8, wherein the step of judging, based on a result obtained by analyzing the anchor video frames, whether the virtual camera position control instruction generated based on the information corresponding to the anchor is obtained comprises a following step:
judging, based on image information obtained by extracting information from the anchor video frames, whether the image information has second preset information, wherein when the image information has the second preset information, it is determined that the virtual camera position control instruction generated based on the information corresponding to the anchor is obtained.

10. The virtual image control method according to claim 9, wherein the second preset information comprises action information, depth information, identification object information and/or identification color information.

11. The virtual image control method according to claim 1, wherein the step of judging whether a virtual camera position control instruction corresponding to the anchor is obtained comprises a following step:
judging, upon receiving a virtual camera position operation instruction sent from the live streaming receiving terminal, whether the virtual camera position operation instruction complies with a second preset condition, wherein the second preset condition is determined based on user historical data corresponding to the anchor, wherein if the virtual camera position operation instruction complies with the second preset condition, it is determined that the virtual camera position operation instruction is obtained.

12. The virtual image control method according to claim 1, wherein the step of controlling the virtual image according to the virtual camera position control instruction and the action control instruction comprises following steps:
controlling a display posture of the virtual image in the live streaming picture according to the action control instruction; and
controlling a display size and/or a display angle of the virtual image in the live streaming picture according to the virtual camera position control instruction.

13. The virtual image control method according to claim 12, wherein the virtual camera position operation instruction comprises an angle parameter; and
the step of controlling a display size and/or a display angle of the virtual image in the live streaming picture according to the virtual camera position control instruction comprises a following step:
controlling the live streaming picture to stop displaying the anchor video frames, and acquiring a part of three-dimensional viewing angle data corresponding to the angle parameter in three-dimensional image data constructed for the virtual image in advance.

14. The virtual image control method according to claim 12, wherein the virtual camera position operation instruction comprises angle information: and
the step of controlling a display size and/or a display angle of the virtual image in the live streaming picture according to the virtual camera position control instruction comprises a following step:
controlling the live streaming picture to stop displaying the anchor video frames, adjusting, according to the anchor video frames, three-dimensional image data constructed for the virtual image in advance, and acquiring a part of three-dimensional viewing angle data corresponding to an angle parameter in the adjusted three-dimensional image data.

15. The virtual image control method according to claim 14, wherein the step of adjusting, according to the anchor video frames, three-dimensional image data constructed for the virtual image in advance comprises following steps:
acquiring coordinate information on a target feature point in the anchor video frames, and calculating coordinate information on other feature points of the virtual image based on the coordinate information; and
adjusting, according to the coordinate information, the three-dimensional image data constructed for the virtual image in advance.

16. The virtual image control method according to claim 12, wherein the virtual camera position operation instruction comprises a zoom parameter; and
the step of controlling a display size and/or a display angle of the virtual image in the live streaming picture according to the virtual camera position control instruction comprises a following step:
determining the display size of the virtual image in the live streaming picture according to the zoom parameter and an initial size of the virtual image.

17. The virtual image control method according to claim 12, further comprises following steps:
acquiring the number of times of displaying the virtual image at the live streaming receiving terminal based on various display angles; and
determining an amount of data when displaying the virtual image based on a display angle according to the number of times of displaying corresponding to various display angles.

18. The virtual image control method according to claim 1, wherein the step of analyzing anchor video frames sent from a live streaming initiating terminal, and generating an action control instruction comprises following steps:
performing image analysis on each of the anchor video frames sent from the live streaming initiating terminal, and generating the action control instruction according to an image analysis result of each of the anchor video frames; or
extracting, every preset period, a current video frame in the anchor video frames sent from the live streaming initiating terminal, performing image analysis on the current video frame, and generating the action control instruction according to an image analysis result on the current video frame.

19. A virtual image control apparatus, wherein the apparatus comprises:
a control instruction generating module, configured to analyze anchor video frames sent from a live streaming initiating terminal, and generate an action control instruction, wherein the anchor video frames are obtained by shooting an anchor by the live streaming initiating terminal, and the action control instruction is configured to control a virtual image in a live streaming picture of a live streaming receiving terminal;
a control instruction judging module, configured to judge whether a virtual camera position control instruction corresponding to the anchor is obtained; and
a virtual image control module, configured to control, when the virtual camera position control instruction is obtained, the virtual image according to the virtual camera position control instruction and the action control instruction.

20. An electronic device, comprising a memory, a processor, and a computer program stored in the memory and being capable of running on the process, wherein the virtual image control method according to claim 1 is implemented when the computer program runs on the processor.

21. (canceled)
